(19) United States
(12) Patent Application Publication
(10) Pub. No.: US 2013/0131420 A1
(43) Pub. Date: May 23, 2013

(54) Hazardous Liquid Triple Containment

(71) Applicant: William G. Culp, Simpsonville, SC (US)

(72) Inventor: William G. Culp, Simpsonville, SC (US)

(73) Assignee: FLUOR TECHNOLOGIES CORPORATION, Aliso Viejo, CA (US)

(21) Appl. No.: 13/302,164

(22) Filed: Nov. 22, 2011

(51) Int. Cl. G21F 3/00; E04C 3/10; E04B 1/00; B65D 88/10

(52) U.S. Cl. 588/16; 52/506.01; 52/173.1; 52/745.01

(57) ABSTRACT

Systems and methods for containing a hazardous fluid are described, in which first and second precast concrete segments are coupled together to form wall elements having a plurality of void spaces. A precast concrete floor segment can be coupled to the wall elements to form a cavity, and a metal liner can be disposed within the cavity to form a container capable of storing a hazardous fluid. An external barrier configured to be impervious to the hazardous fluid can be coupled to an exterior portion of at least one of the first and second segments.

### FIELD OF THE INVENTION

The field of the invention is systems and methods for storing hazardous fluids.

### BACKGROUND

Nuclear facility radioactive waste storage buildings and other hazardous liquid storage tanks are typically built with stainless steel for a 60 year lifespan. Often these facilities must be seismically designed to be housed within a structure that provides a second barrier between the hazardous liquid and the external environment. The configuration of hazardous liquid storage tanks and facilities are regulated in the U.S. by the Nuclear Regulatory Commission (“NRC”), which requires waste storage buildings to act as a basin to collect any spill from internal tanks (see NRC Regulatory Guide 1.143).

Radioactive waste (“radwaste”) from a nuclear power plant includes liquids from the reactor water cleanup system, the condensate cleanup system, the chemical and volume control system, the reactor coolant and auxiliary building equipment drain tanks, the sumps and floor drains provided for collecting liquid wastes, the boron recovery system, equipment used to prepare solid waste solidification agents, the building ventilation systems (heating, ventilating, and air conditioning), instrumentation and sampling systems beyond the first root valve, or the chemical fume hood exhaust systems. The design and construction of radwaste management systems should provide assurance that radiation exposures to operating personnel and to the general public are as low as is reasonably achievable. These requirements generally add significant cost to the radwaste management systems.

Radwaste systems have specific requirements to ensure system reliability, operability, and availability. For example, the foundations and walls of structures housing the radwaste system must be designed to account for natural phenomena and internal and external man-induced hazards criteria described in the Regulatory Guide and have a height sufficient to contain the maximum liquid inventory expected to be stored in the system.

According to current regulations, all radwaste tanks, overflows, drains, and sample lines must be routed to a liquid radwaste treatment system. Indoor radwaste tanks must have curbs or elevated thresholds with floor drains routed to the liquid radwaste treatment system. Retention by an intermediate sump or drain tank configured to handle radioactive materials and have provisions for routing to the liquid radwaste system is also acceptable.

The radioactive waste management structures, systems and components (SSC) must also be configured to control leakage and facilitate access, operation, inspection, testing, and maintenance in order to maintain radiation exposures to operating and maintenance personnel as low as is reasonably achievable. The SSC must further include provisions to prevent leakage from entering unmonitored and nonradioactive systems and surrounding ductwork.

For buildings housing radwaste systems, the foundation and walls up to the spill height of the contained radwaste storage systems should meet the criteria of the Regulatory Guide Tables 1, 2, 3, and 4, regardless of the building safety classification. For classifications RW-IIb and RW-IIc, all SSCs should be designed at least for seismic base shear requirements of the Standard Uniform Building Code (UBC), 1997. The guidance of Volume 2 of the UBC 1997 and American Society of Civil Engineers ASCE 7-95, “Minimum Design Loads for Buildings and Other Structures,” should be used as noted in Table 2 of the Regulatory Guide.

Regulatory Guide, Table 1, covers codes and standards for the design of SSC in radwaste facilities including component design, construction materials, welding, inspection, and testing. Concrete structures must be built to ACI-318 or ACI 349. Steel structures must be constructed to Steel (Hot Rolled) AISC-ASD or AISC LFRD or AISC N-690(S327) or ASTM-A36. For welding, AWS-D1.1 AISC Standards and AWS Standards, Structures-Steel (Cold Formed) AISI SG-673 ASTM-A500 AWS-D1.3, D9.1 AISC Standards and AWS Standards.

Depending on the hazard level, the facility also has to withstand earthquakes greater than typical IBC design (Operating Basis Earthquake or ½ SSE in the Owner's NRC License), and wind loading up to ASCE 7-95, Category III. The facility also must also be within a “protected area”, which can increase the cost of larger radwaste management systems. By reducing the size of the radwaste management system, the protected area and security costs could also be reduced.

The costs to decommission radwaste buildings are also high because radioactive fluids can include a mixture of resins and contaminated or activated corrosion and wear products that contain various isotopes with various half-lives. Some radwaste storage tanks at Department of Energy sites are simple single containment tanks that have been in service longer than 60 years and were not necessarily built with a means of leak detection; they have accumulated sludge in them that has to be disposed of. These tanks have been known to corrode and leak.

To solve some of these problems, it was proposed to reduce the radwaste building length and width by about half for a 1300 MW nuclear power plant by building liquid storage pools into the radwaste building structure. In typical nuclear fuel pools, a stainless steel liner is welded to embedments, or the liner plate is selected to be thick enough, with stiffeners, to be used as a concrete form for poured in place walls. In such instances, leak channels are welded to each seam, which increases the cost of the storage system. In addition, because the pools are constructed on-site, the construction cost and time to completion is increased.

Although factory-manufactured concrete forms have been used in water treatment and other similar fields for field fabricating cast-in-place large unlined concrete tanks, these tanks lack high leak integrity requirements and are unsuitable for radwaste or hazardous waste storage.

All extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for improved radwaste containment systems and methods that reduce the installation time and cost while providing additional protection against leakage.

### SUMMARY OF THE INVENTION

The inventive subject matter provides apparatus, systems and methods for hazardous fluid containment including, for example, storing hazardous chemicals, radioactive or other hazardous waste, and potent pharmaceuticals.

In one aspect, a hazardous fluid containment device can include first and second precast concrete segments coupled together to form wall elements having a plurality of void spaces, and a precast concrete floor segment coupled to the wall elements to form a cavity. As used herein, the term “precast concrete segments” means pre-stressed concrete modules that are post-tensioned. Such precast segments advantageously provide a low cost structure capable that can be configured to store hazardous fluid.

A preferably metal liner can be disposed within the cavity, and coupled to at least one of the first and second segments to form a container capable of storing the hazardous fluid. A coating or other barrier can be applied to an external surface of at least one of the first and second segments, which is preferably impervious, or configured to be impervious, to the hazardous fluid to be stored within the device. Thus, in this manner, a triple barrier containment device configured to store hazardous fluid can be created using precast components.

In another aspect, methods of forming a hazardous fluid containment device are contemplated that include coupling first and second pairs of precast concrete segments to form wall elements having a plurality of void spaces. The wall elements can be coupled with a precast concrete floor segment to form a cavity.

To form a container capable of storing a hazardous fluid, a metal liner can be disposed within the cavity and coupled to at least one of the first and second segments. An external barrier impervious to the hazardous fluid can be disposed about an exterior portion of at least one of the first and second segments. Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a top-view schematic of one embodiment of a hazardous fluid containment device.

FIGS. 2A-2B are top-view schematics of various embodiments of wall elements.

FIG. 3A is a plan view of another embodiment of a hazardous fluid containment device, and FIG. 3B is an enlarged view of a portion of the hazardous fluid containment device of FIG. 3A.

FIG. 3C is an elevation view of the hazardous fluid containment device of FIG. 3A, and

FIG. 3D is an enlarged view of a portion of the elevation view of FIG. 3C.

FIG. 4 is a flowchart of one embodiment of a method of forming a hazardous fluid containment device.

### DETAILED DESCRIPTION

One should appreciate that the disclosed techniques provide many advantageous technical effects including providing a triple containment storage unit that preferably has a modular design capable of providing additional flexibility to handle unexpected waste volumes and ensure a lower cost when compared with known containment devices. In this manner, individual storage containers can be replaced in the hazardous fluid containment device should a leak be detected in one or more of the containers. In addition, the invention subject matter described herein can advantageously reduce the building size required to contain the storage unit, the quantities of building materials required, and the need for separately fabricated tanks, all with a shortened field construction time and cost.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

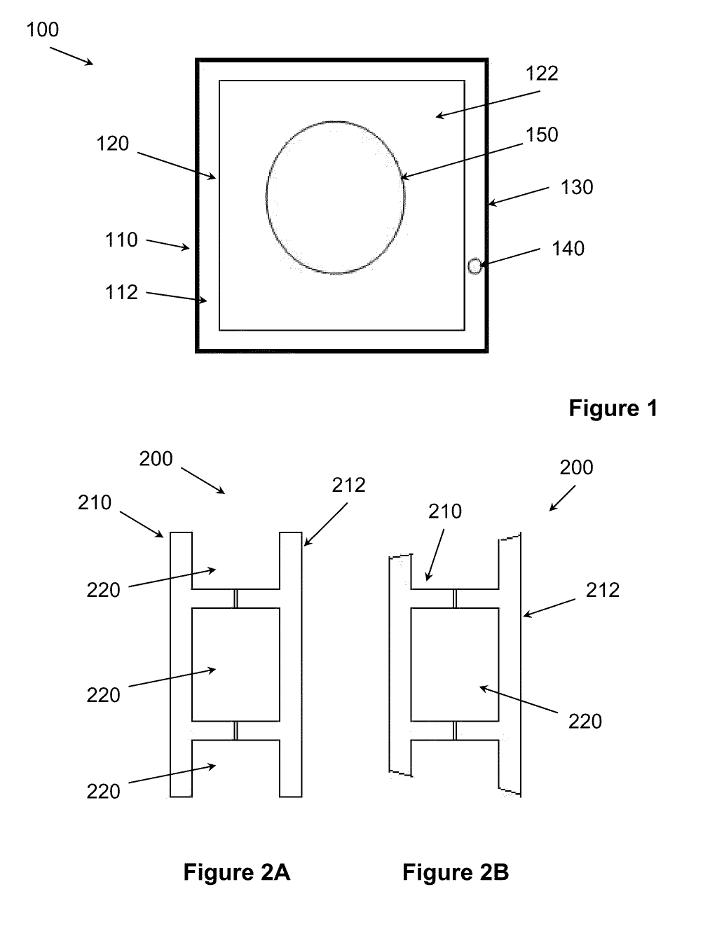

In FIG. 1, one embodiment of a hazardous fluid containment device 100 is shown having first and second precast concrete segments coupled together to form wall element 110 having a plurality of void spaces (not shown). Although not shown, a precast concrete floor segment is preferably coupled to the wall element 110 to form a cavity 112. It is contemplated that the device 100 could have multiple sets of precast concrete segments to form additional wall elements that can thereby surround the cavity 112.

A liner 120 can be disposed within the cavity 112 and be coupled to at least one of the wall elements 110 to form a container 122 within cavity 112 capable of storing a hazardous fluid. In this manner, the liner 120 can act as a primary barrier of the device 100 to contain the hazardous fluid. Preferably, the metal liner is composed of stainless steel, although the liner could alternatively comprise other metals or metal composites, or other commercially suitable material(s) or combination(s) thereof, such that the container 122 can store a hazardous fluid.

Liner 120 advantageously can be much thinner than liners used in prior art solutions, and can advantageously reduce the complexity of installation by reducing the amount of field welding and testing required. In some embodiments, a bladder 150 can be disposed within the container 122, and is preferably maintained at a vacuum. The bladder 150 can be similar to those used in the fuel or bulk water storage.

A sump 140 can be disposed within the cavity 112 or be coupled to a wall element 110 to thereby facilitate drainage of any hazardous fluid that might leak through liner 120. Although not shown in FIG. 1, it is preferred that the sump 140 be fluidly coupled to one or more fluid conduits disposed within the floor segment or elsewhere within device 100, such that hazardous fluid can be removed as needed from the device 100. In this manner, device 100 can eliminate the need for leak channels disposed behind seams of the liner 120, as the entire liner 120 can be monitored for leaks.

An external barrier 130 configured to be impervious to the hazardous fluid can be applied to or otherwise coupled to an exterior portion of at least one of the wall elements 110. The external barrier 130 is preferably configured to hold hazardous materials in both primary and secondary containment applications. The specific barrier to be used will depend upon the type of hazardous fluid to be contained in device 100. For example, specific impervious and chemical-resistant geomembranes are currently required by U.S. regulations to provide containment of various chemicals, liquids, leachate and other industrial/municipal waste products. In addition, because most of the barriers can be relatively small, it is preferred that the liners are fabricated in a single piece prior to shipping to the installation site.

Device 100 can thus include at least three barriers to prevent leakage of the hazardous fluid: metal liner 120, wall element 110, and external barrier 130.

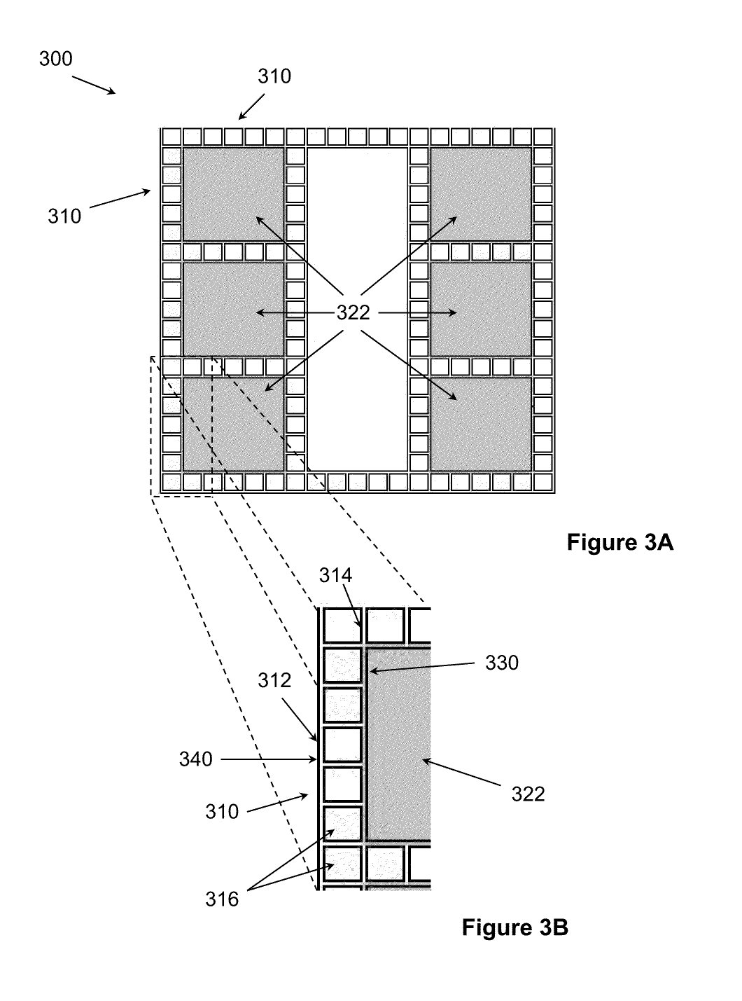

FIGS. 2A-2B illustrates various embodiments of wall elements 200 that each comprises first and second precast concrete segments 210 and 212, respectively, which are coupled together to form a plurality of void spaces 220. Preferably, each of the first and second precast segments 210 and 212 comprises a precast double tee section. By utilizing precast, post-tensioned concrete segments, this advantageously minimizes field erection costs to build the fluid containment device. An example of the current art of pre-stressed, post-tensioned concrete can be found on http://www.andrewsprestressedconcrete.com/id9.htm. Typical conventional connection detail of double tee section can be found in the PCI Handbook, 6^{th} Edition, page 3-53. After properly coupled the first and second segments 210 and 212, an essentially leak-tight barrier can be formed.

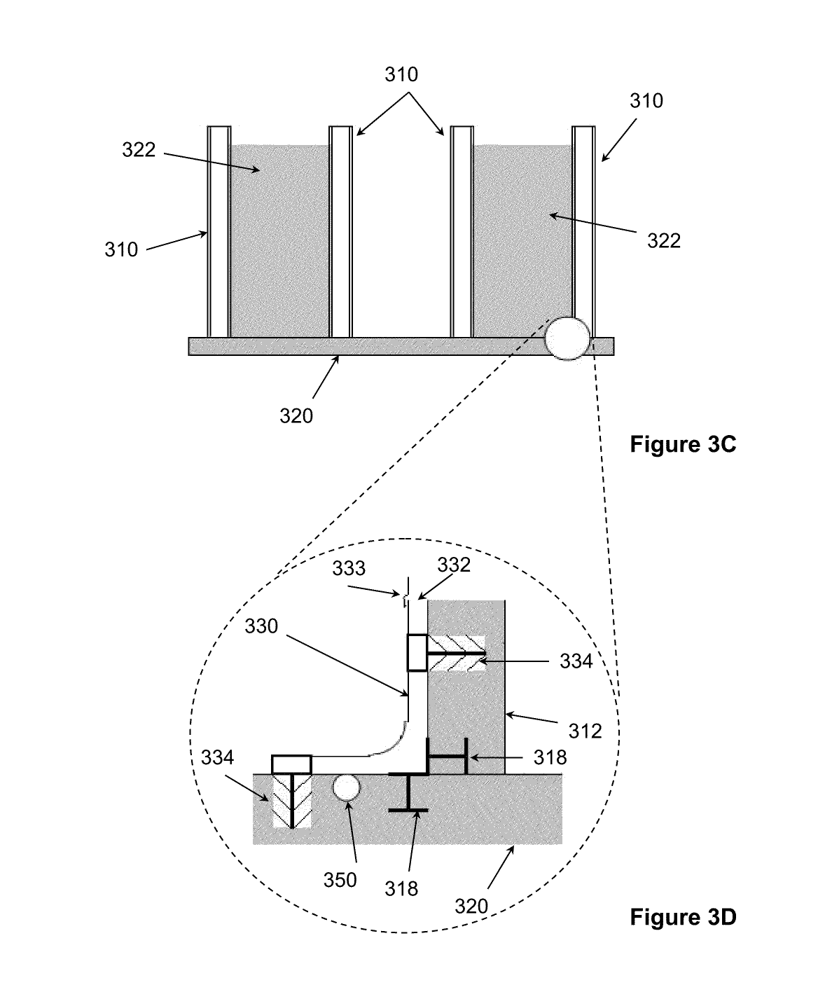

In FIGS. 3A-3D, an alternative embodiment of a hazardous fluid containment device 300 is shown having a plurality of wall elements 310. Each of the wall elements 310 preferably comprises first and second precast concrete segments 312 and 314, respectively, which are coupled together to form a plurality of void spaces 316. It is especially preferred that each of the precast concrete segments comprises a precast concrete floor, wall, or ceiling segment that is factory manufactured, pre-stressed and post-tensioned off-site to thereby reduce on-site erection and labor costs. In contrast, pouring concrete on-site could alone equate to approximately ⅔ of the cost of precast segments, and thereby require significantly more time to construct the device 300. Precast concrete segments advantageously require far less concrete and are installed much faster than an equivalent cast in place wall. In addition, precast segments eliminate the need for form work, which represents approximately ⅔ of the total cost of cast-in-place walls. Furthermore, because the precast concrete segments are commonly used in many areas of construction, including bridges, office buildings, and parking and other structures, the segments are premade and do not require special manufacturing.

The first and second segments 312 and 314 are preferably of approximately the same size and dimension, and can be coupled together to form a wall element 310 that includes horizontal post-tension void spaces 316. This advantageously provides a very strong and rigid wall element 310 capable of resisting significant seismic and wind loads, while acting as a tank surface and leak collection plenum. The segments 312 and 314 can be coupled together by welding together weld plates 318 that are embedded into each of the segments 312 and 314 during manufacturing. Additional information concerning manners to couple the segments can bed found in the PCI Handbook, 6^{th} Edition on page 3-53.

A precast concrete floor segment 320 can be coupled to one or more of the wall elements 310 to form cavity 332. In some embodiments, the floor segment 320 can comprise one or more pre-stressed concrete segments, which can have the same of varied thicknesses depending on the specific application, and could include hollow core slabs. It is contemplated that the floor segment 320 could have a thickness of at least 6 in, at least 8 in, at least 10 in, or even 1 ft or more. Optionally, the floor segment 320 can include one or more leak collection pipes or channels (not shown) that can be fluidly coupled to a sump configured to monitor for leakage of the hazardous fluid. In this manner, should any fluid be detected, the leaked fluid can be removed from the device 300 via the sump and leak collection pipe(s).

A preferably metal liner 330 can be disposed within the cavity 332 and coupled to at least one of the first and second segments 312 and 314 and/or floor segment 320 to form a container 322 capable of storing a hazardous fluid. In some contemplated embodiments, the liner 330 can be substantially composed of stainless steel, although any commercially suitable material(s) could be used including, for example, other metals, metal composites, or combination(s) thereof.

In some contemplated embodiments, at least one of the first segment 312, the second segment 314, and the floor segment 320 can include one or more embedded liner grips 334, which are preferably configured to allow for attachment of the metal liner 330 to the precast concrete segment(s). In this manner, the liner 330 can be quickly and easily fastened to the wall elements 310 and/or floor segment 320 to create the container 322 by attaching the liner 330 to the liner grips 334 using welded studs or other commercially suitable fasteners. It is contemplated that the liner grips 334 could be configured to withstand a design basis hydrostatic load under the liner 330 should a leak occur.

Preferably, the liner grips 334 are each configured to capture an anchor button having a serrated or otherwise non-planar surface, such that the anchor button can be resistance welded to the grips 334. This allows the anchor button to be captured by a liner grip 334 by simply pressing the liner 330 in place. By embedding the liner grips 334 into at least one of the first segment 312, second segment 314, and floor segment 320 during manufacturer at defined distances from one another, the anchor buttons can be pre-attached to the liner 330 such that the liner 330 can be quickly attached to the liner grips 334 by press-fitting the anchor buttons to the liner grips 334.

Alternatively, at least one of the first segment 312, the second segment 314, and the floor segment 320 can include a plastic anchoring system that is preferably cast-in-place as the concrete is formed, and is configured to couple the liner 330 to the at least one of the first segment 312, the second segment 314, and the floor segment 320. An exemplary system is currently offered for sale by AccuGeo™, which can be used with PVC, Coolguard, XR-5 and HDPE.

For a containment system having multiple hazardous fluid containers 322, it is contemplated that the liner 330 could be varied within one or more of the containers 322, such that different types of hazardous fluids could be contained in adjacent containers 322.

A barrier 340 impervious to the hazardous fluid to be contained within device 100 can be coupled, and is preferably externally applied, to an exterior portion of the wall segment 310 (e.g., side facing away from container 322), which thereby provides an additional barrier against leakage of the hazardous fluid.

As shown in FIG. 3D, the device 300 can include a sump 350 embedded in floor segment 320 and configured to remove any leaked fluid from the liner 330 or liner seam 333. In this manner, liner seam 333 does not require expensive leak channels and individual testing because the entire liner surface is monitored for leakage. Alternatively or additionally, sump 350 or an additional sump could be embedded or otherwise coupled to at least one of the first and second segments 312 and 314. In some contemplated embodiments, the sump 350 can include one or more sensors configured to detect a presence (leak) of the hazardous fluid. Alternatively, the sensor could be separate from sump 350 and coupled to the floor segment 320 or at least one of the first and second segments 312 and 314. In such embodiments, it is contemplated that the sensor be functionally coupled to the sump 350. Preferably, the sensor is configured to detect a presence of the hazardous fluid in at least one of the void spaces and a space between the liner 330 and at least one of the first and second segments 312 and 314. It is especially preferred that the device 300 includes sufficient sensors such that leakage of the hazardous fluid through each containment barrier can be detected.

It is further contemplated that the sensors can transmit sensor data via a wired or wireless connection to a remote monitor, such that leakage within device 100 can be continually monitored.

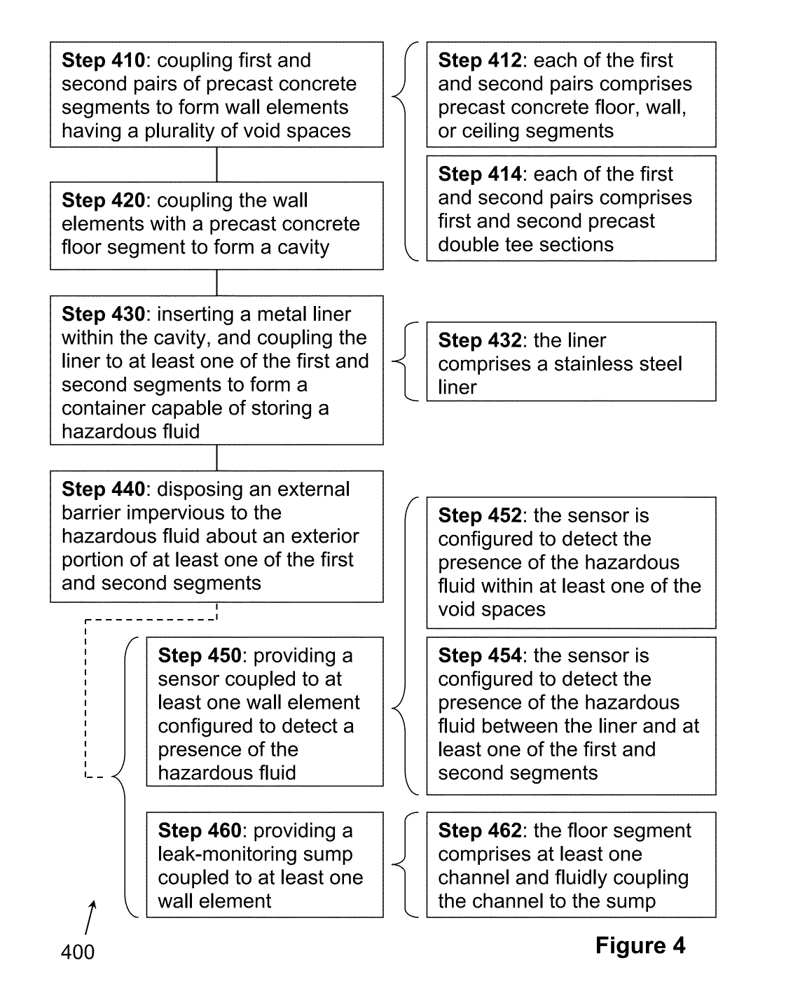

In FIG. 4, one embodiment of a method 400 of forming a hazardous fluid containment device is shown that includes step 410 of coupling first and second pairs of precast concrete segments to form wall elements having a plurality of void spaces. Preferably, in step 412, each of the first and second pairs comprises precast concrete floor, wall, or ceiling segment(s). Even more preferably, in step 414, each of the first and second pairs comprises first and second precast double tee sections.

In step 420, the wall elements can be coupled with a precast concrete floor segment to form a cavity. A metal liner can be disposed within the cavity in step 430, and the liner is preferably coupled to at least one of the first and second segments to form a container capable of storing a hazardous fluid. In step 432, the liner is preferably a stainless steel liner. An external barrier impervious to the hazardous fluid can be disposed about an exterior portion of at least one of the first and second segments in step 440 to thereby create an additional barrier against leaks.

Optionally, in step 450, a sensor can be provided that is coupled to at least one wall element configured to detect a presence of the hazardous fluid. It is contemplated that the sensor can be configured to detect (a) the presence of the hazardous fluid within at least one of the void spaces in step 452 or (b) the presence of the hazardous fluid between the liner and at least one of the first and second segments in step 454.

A leak-monitoring sump can also be provided in step 460 that is coupled to at least one wall element. In step 462, the floor segment can comprise at least one channel, which can be fluidly coupled to the sump.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A hazardous fluid containment device, comprising:
first and second precast concrete segments coupled together to form wall elements having a plurality of void spaces;
a precast concrete floor segment coupled to the wall elements to form a cavity;
a metal liner disposed within the cavity and coupled to at least one of the first and second segments to form a container capable of storing a hazardous fluid; and
an external barrier coupled to an exterior portion of at least one of the first and second segments, and configured to be impervious to the hazardous fluid.

2. The device of claim 1, wherein each of the first and second precast segments comprises a precast concrete floor, wall, or ceiling segment.

3. The device of claim 1, wherein each of the first and second precast segments comprises a precast double tee section.

4. The device of claim 1, wherein the liner comprises a stainless steel liner.

5. The device of claim 1, further comprising a sensor coupled to at least one of the first and second segments, and configured to detect a presence of the hazardous fluid.

6. The device of claim 5, wherein the sensor is configured to detect the presence of the hazardous fluid within at least one of the void spaces.

7. The device of claim 5, wherein the sensor is configured to detect the presence of the hazardous fluid between the liner and at least one of the first and second segments.

8. The device of claim 1, further comprising a leak-monitoring sump coupled to the wall elements.

9. The device of claim 8, wherein the floor segment comprises at least one channel fluidly coupled to the sump.

10. The device of claim 1, wherein at least one of the first and second segments further comprises embedded liner grips configured to allow for attachment of the metal liner to at least one of the first and second segments.

11. The device of claim 1, wherein the hazardous fluid is radioactive.

12. A method of forming a hazardous fluid containment device, comprising:
coupling first and second pairs of precast concrete segments to form wall elements having a plurality of void spaces;
coupling the wall elements with a precast concrete floor segment to form a cavity;
inserting a metal liner within the cavity, and coupling the liner to at least one of the first and second segments to form a container capable of storing a hazardous fluid; and
disposing an external barrier impervious to the hazardous fluid about an exterior portion of at least one of the first and second segments.

13. The method of claim 12, wherein each of the first and second pairs comprises precast concrete floor, wall, or ceiling segments.

14. The method of claim 12, wherein each of the first and second pairs comprises first and second precast double tee sections.

15. The method of claim 12, wherein the liner comprises a stainless steel liner.

16. The method of claim 12, further comprising the step of providing a sensor coupled to at least one wall element configured to detect a presence of the hazardous fluid.

17. The method of claim 16, wherein the sensor is configured to detect the presence of the hazardous fluid within at least one of the void spaces.

18. The method of claim 16, wherein the sensor is configured to detect the presence of the hazardous fluid between the liner and at least one of the first and second segments.

19. The device of claim 12, further comprising the step of providing a leak-monitoring sump coupled to at least one wall element.

20. The device of claim 19, wherein the floor segment comprises at least one channel, and fluidly coupling the at least one channel to the sump.
